(19) United States
(12) Patent Application Publication
(10) Pub. No.: US 2019/0065517 A1
(43) Pub. Date: Feb. 28, 2019

(54) FILE PREVIEW AND SELECTIVE ACCESS TO FILE CONTENT OF ARCHIVED FILE

(71) Applicant: Microsoft Technology Licensing, LLC, Redmond, WA (US)

(72) Inventors: Can Comertoglu, Seattle, WA (US); Edgar Banguero, Seattle, WA (US); Emmanuel Miranda-Steiner, Seattle, WA (US); Sari Jack, Seattle, WA (US); Sridhar Periasami, Seattle, WA (US); Harshad Sheth, Seattle, WA (US)

(21) Appl. No.: 15/807,015

(22) Filed: Nov. 8, 2017

Related U.S. Application Data
(60) Provisional application No. 62/552,777, filed on Aug. 31, 2017.

(51) Int. Cl. G06F 17/30

(52) U.S. Cl. CPC G06F 17/30126; G06F 3/04842; G06F 17/30106; G06F 17/30073

(57) ABSTRACT

Non-limiting examples of the present disclosure describe an application/service that is configured to access an archived file and allow retrieval of specific file content from a preview of the archived file without having to download the entire archived file. A selection of an archived file may be received through a user interface of an application/service. A preview of the archived file may be displayed through the user interface based on the received selection. The preview of the archived file may comprise file content of the archived filed that is accessed without downloading of the archived file. Specific file content may be extracted from the archived file based on a selection of specific file content from the displayed preview. The user interface is configured to enable a user to manually select specific file content from complete contents of the archived file. Access may be provided to the specific file content extracted.

### CROSS-REFERENCE TO RELATED APPLICATIONS

This application claims priority to U.S. Provisional Patent Application No. 62/552,777, entitled “FILE PREVIEW AND SELECTIVE ACCESS TO FILE CONTENT OF ARCHIVED FILE”, filed on Aug. 31, 2017, which is incorporated by reference herein in its entirety.

### BACKGROUND

Zip files tend to be large. Users can have thousands of files in a zip file. However, sometimes users just need one, or a few files instead of the entire collection. Today, a user has to download the entire zip file from the web client (which can be gigabytes large) just to reach the few files they may need access to. This may not even be possible on certain internet connections, or devices where available storage is not enough to download the large zip file. Some products may be configured to provide a web preview of what's contained in the zip file. However, with such products, users still are required to download the full zip file to access any file in the collection. This is tedious for the user as well as inefficient from a processing standpoint (device-wise, application-usage wise, user interaction-wise, etc.).

### SUMMARY

As such non-limiting examples of the present disclosure describe an application/service that is configured to access an archived file (e.g. compressed file) and allow users to retrieve specific file content (e.g. files and/or folders) from a preview of the archived file without having to download the entire archived file. An exemplary preview of content of the archived file may be generated and presented to a user, where the user can browse content of the archived file without being required to download the entire archived file. In one instance, a selection of an archived file may be received, for example, through a user interface of an application/service. A preview of the archived file may be displayed through the user interface, for example, based on the received selection. The preview of the archived file may comprise file content of the archived filed that is accessed without downloading of the archived file. Specific file content may be extracted from the archived file based on a selection of specific file content from the displayed preview. The user interface is configured to enable a user to manually select specific file content from complete contents of the archived file. Access may be provided to the specific file content extracted.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 illustrates an exemplary method for generating an exemplary preview of an archived file and providing selective access, through the exemplary preview, to specific content of the archived file with which aspects of the present disclosure may be practiced.

FIGS. 2A-2C are exemplary processing device views illustrating operation of an application/service that provides an exemplary preview of an archived file and management options for specific content of the archived file with which aspects of the present disclosure may be practiced.

FIG. 3 is a block diagram illustrating an example of a computing device with which aspects of the present disclosure may be practiced.

FIGS. 4A and 4B are simplified block diagrams of a mobile computing device with which aspects of the present disclosure may be practiced.

FIG. 5 is a simplified block diagram of a distributed computing system in which aspects of the present disclosure may be practiced.

### DETAILED DESCRIPTION

Non-limiting examples of the present disclosure describe an application/service that is configured to access an archived file (e.g. compressed file) and allow users to retrieve specific file content (e.g. files and/or folders) from a preview of the archived file without having to download the entire archived file. An exemplary preview of content of the archived file may be generated and presented to a user, where the user can browse content of the archived file without being required to download the entire archived file. For instance, a user can choose to access specific file content of an archived file through actions such as: selective downloading, viewing, extracting, etc. Specific content may be a single file (folder, directory, etc.) from complete file content of the archived file. In further examples, the application/service is configured to enable additional components to extend functionality of a user interface that is used to provide an exemplary preview of the archived file. For example, a search component and/or web browser component may be incorporated within the user interface to improve processing efficiency when accessing the archived file as well as enhance user interaction with an exemplary application/service. Further examples of the present disclosure may extend to full web-service examples where a user may be managing content that is stored on a distributed network storage. For instance, a user account may be associated with a web-based serviced for file management (e.g. Microsoft® OneDrive®), where enhanced server-side processing operations enable a user to selectively access content of an archived file without having to download the entire archived file (temporarily or permanently) to a storage associated with the user account.

Accordingly, the present disclosure provides a plurality of technical advantages including but not limited to: generation of interactive previews of archived files that enable users to access specific content of an archived file without requiring download of the archived file, improved processing efficiency (e.g. reduction in processing cycles, reduction in latency, better management of storage/memory of computing devices) for computing devices that are utilized to access archived files, improved user interaction with applications/services that are used to access archived files including enhanced user interface that enables management of file content of an archived file through previews/web previews, improved interaction for devices in service-based technical environments where improved processing on server-side computing devices can improve processing efficiency for client-side computing devices and extensibility to integrate search interface components, web browser components, productivity applications/services, etc., for example, to enhance functionality when previewing content of archived files.

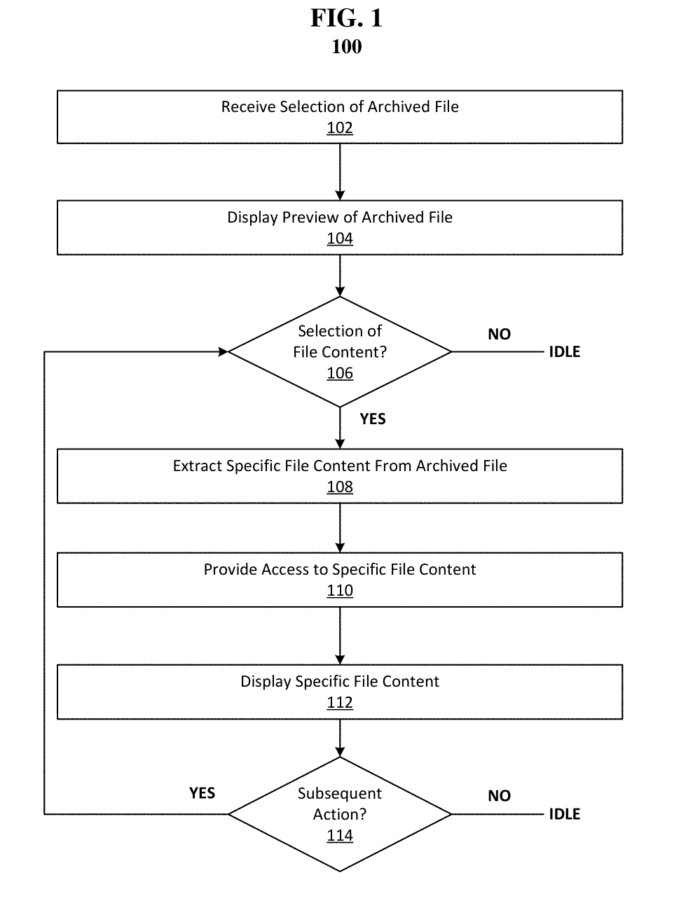

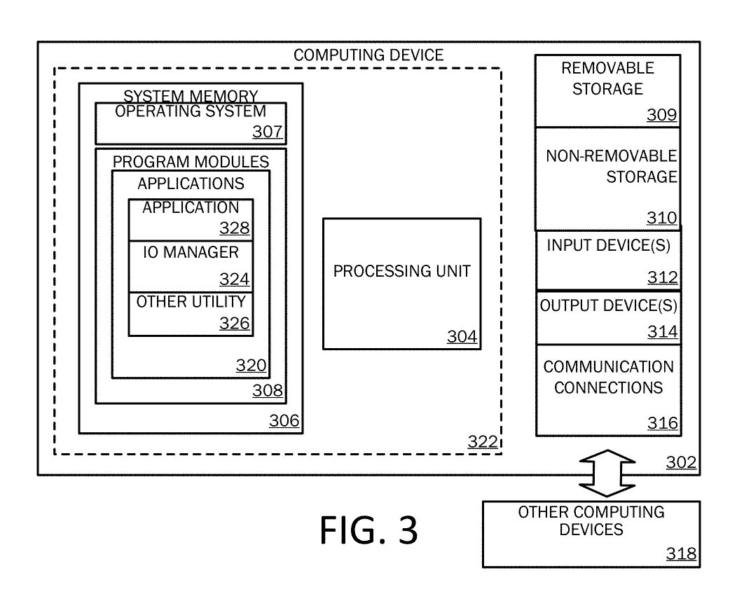

FIG. 1 illustrates an exemplary method 100 related to generating an exemplary preview of an archived file and providing selective access, through the exemplary preview, to specific content of the archived file with which aspects of the present disclosure may be practiced. As an example, method 100 may be executed by an exemplary processing device and/or system such as those shown in FIGS. 3-5. In examples, method 100 may execute on a device comprising at least one processor configured to store and execute operations, programs or instructions. Operations performed in method 100 may correspond to operations executed by a system and/or service that execute computer programs, application programming interfaces (APIs), neural networks or machine-learning processing, among other examples. As an example, processing operations executed in method 100 may be performed by one or more hardware components. In another example, processing operations executed in method 100 may be performed by one or more software components. In some examples, processing operations described in method 100 may be executed by one or more applications/services associated with a web service that has access to a plurality of application/services, devices, knowledge resources, etc. Processing operations described in method 100 may be implemented by one or more components connected over a distributed network.

Method 100 begins at processing operation 102, where a selection of an archived file may be received. In one example, a selection of an archived file may be received (processing operation 102) through a user interface of an application/service. An exemplary application/service may be configured for file management that provides a user interface for management of file data such as computer files, folders, directories, etc. and associated metadata. In one instance, an exemplary file management application may be provided through an operating system (OS) that is executing on a computing device. In other instances, file management services may be accessible over a network connection, for example, where examples herein may be configured to work with a web browser component. In one example, an exemplary user interface is a component of a web service that is used to access and manage file content. In such instances, an exemplary user interface and related processing operations described herein may be executed by one or more computing devices over a distributed network connection). In other examples, processing operations described herein may be integrated into other applications/services to improve processing operations and user interaction when working with archived files. For instance, software updates may be utilized to provide enhanced functionality for existing applications/services and/or an application programming interface (API) may be configured to extend functionality of an application/service.

An archive file is a file that is composed of one or more computer files along with metadata, where multiple computer files may be compressed together as a single file for easier portability and storage of file content. Examples of archive file formats comprise but are not limited to: zip, rar, 7z, tar, jar, war and image files (e.g. ISO), among other examples. It should be understood that processing operations described herein can be applied to other file types that may compress or layer data without departing from the spirit of the present disclosure. As archived files are used to increase processing efficiency for portability and storage of file content, examples described herein are directed to further improving processing efficiency of in the technical arts of file storage and file portability (including computing devices used for such processing) as well as transmission of data between computing devices (e.g. in a service-based networking example) and improving application/services for file management processing (including an improved user interface for management of archived files).

Selection (processing operation 102) of the archived file may occur through means that is known to one skilled in the art such as: touch/gesture input, device action (e.g. mouse click, stylus, keyboard data entry, etc.) and voice input, among other examples. For example, a zip file may comprise compressed content where a user may desire to extract file data from the compressed content. A user may select a zip file, where an exemplary preview of file content of the zip file may be provided through a user interface of an application/service. An exemplary user interface may be configured to enable the user to locate (e.g. files/folders) archived files and select the archived files for subsequent action. In another instance, an archived file may be sent to a user through a messaging service (e.g. email, instant message, etc.), where a user may select the archived file for access.

Flow of method 100 may proceed to processing operation 104, where an exemplary preview of the archived file may be displayed through the user interface of the application/service. A preview of the archived file may be displayed through the user interface, for example, based on the selection received in processing operation 102. The preview of the archived file may comprise file content of the archived filed that is accessed without downloading of the archived file, where a user can browse content of the archived file without being required to download the entire archived file on their client computing devices.

An exemplary preview may be displayed (processing operation 104) through the user interface based on processing executed by one or more computing devices (e.g. server-side computing devices) associated with a web service. A preview of the archived file is generated and surfaced (for viewing) by one or more computing devices of a web service that are separate from computing devices and/or storage that may be associated with a user account. For instance, a user account may be associated with a web-based serviced for file management (e.g. Microsoft® OneDrive®), where enhanced server-side processing operations enable a user to selectively access content of an archived file without having to download the entire archived file (temporarily or permanently) to a storage associated with the user account. This enables users to better manage storage on their computing devices (or distributed storage space) as well as saving computing cycles and processing resources, where users can access complete file contents of an archived file remotely and selectively download specific content without having to use more storage space and computing resources to manage complete contents of an archived file. While distributed network storage examples enable users remote access to content, such functionality does not extend to management of archived files where specific content of an archived file can be selectively downloaded. Examples of the present disclosure enable an exemplary user interface to provide a user with control over management of specific contents of an archived file without having the archived file stored in memory of a computing device that seeks to download the specific file content of the archived file.

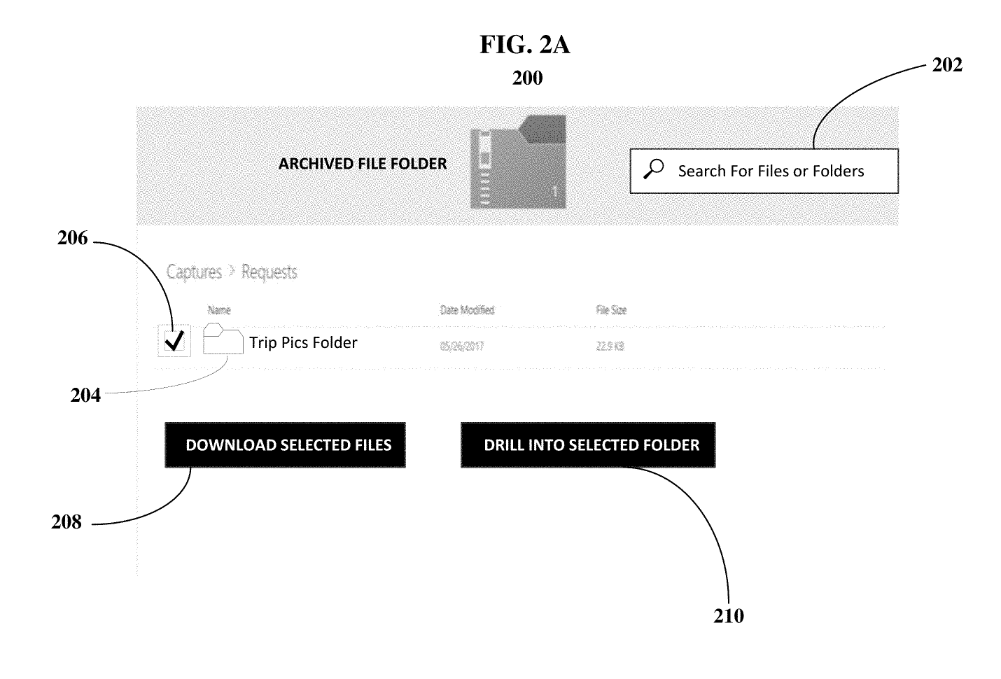

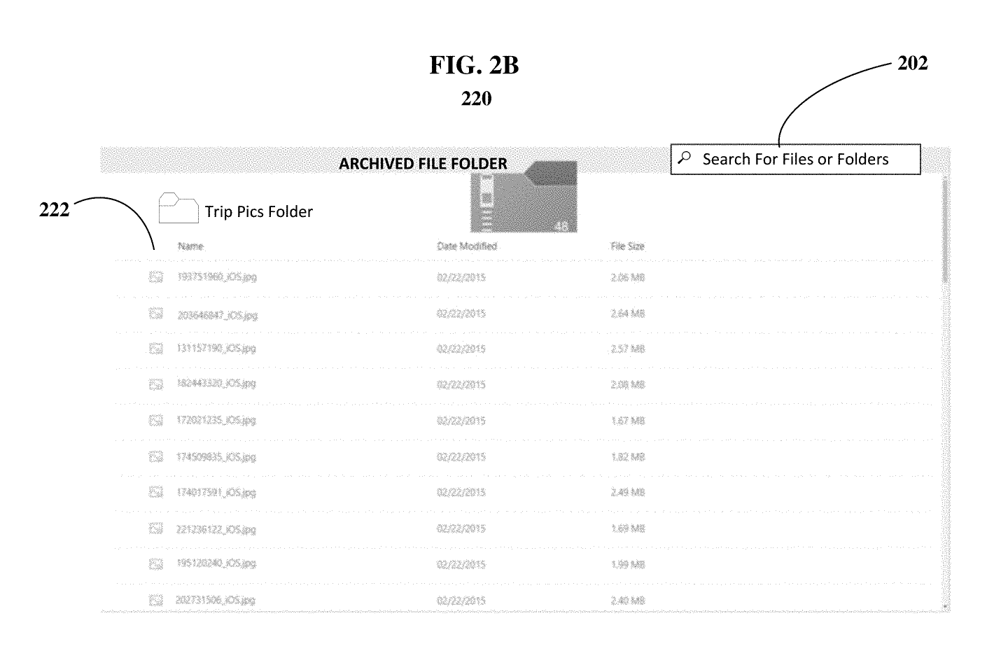

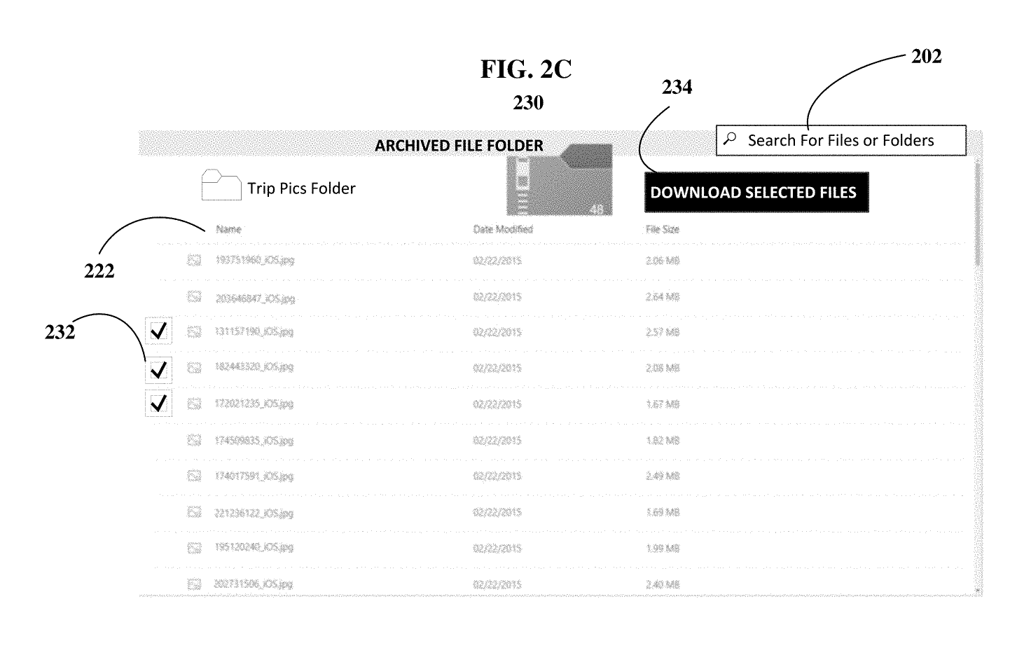

Processing operation 104 may further comprise back-end processing operations to analyze and parse data of the archived file. In one example, presentation of an exemplary preview may comprise generation of a listing of files, folders, directories, etc. that may be presented through the user interface for a user to navigate through and select specific file content for access. Non-limiting examples of a preview for the archived file are illustrated in FIGS. 2A-2C. In further examples, functionality of a preview may be expanded to include a sampling of specific file content for the user to review before determining whether to actually download the specific file content. In such instances, an exemplary application/service may interface with other applications/services (e.g. productivity applications/services of a platform or third-party applications/services, etc.) to enable analysis of specific types of content. For example, if a file is a word processing document, a word processing application may be utilized to provide a preview of that file. If a specific file content is image content, image processing applications/services and/or optical recognition processing may be applied to generate a preview of the image content.

In even further instances, analysis of specific content may yield contextual suggestions that can be surfaced to the user in coordination with navigation of a displayed preview of the archived file. For example, suggestions for relationships between content of the archived file may be surfaced, sharing suggestions (e.g. with other user accounts of an exemplary application/service), calendaring suggestions, suggestions of other application/service to utilize for access and/or sharing of specific file content and any other suggestion of contextually related content (e.g. web search results, related entities, etc.) may be surfaced through an application/service, OS or related application/service.

Flow of method 100 may proceed to decision operation 106, where it is determined whether a selection of specific file content is made from the complete contents provided in the displayed preview (processing operation 104). If no selection occurs, flow of decision operation 106 branches NO and processing of method 100 remains idle until subsequent action is received. The user interface may be configured to have the user manually browse content provided in the displayed preview. For instance, users can browse through specific folders/directories to locate specific file content. In further examples, the user interface further comprises a search component to enable the user to search for the specific file content from the complete contents of the archived file. For instance, the user interface is configured to enable a user to enter specific terms, words, phrases, symbols, etc., where complete contents of the archived file can be accessed and searched by one or more computing devices of the web service. Search results may be prominently displayed for a user to select specific content. If a selection of specific file content is received through the user interface, flow of decision operation 106 branches YES and processing of method 100 proceeds to processing operation 108.

At processing operation 108, specific file content may be extracted from the archived file based on a selection (received at decision operation 106) of specific file content from the displayed preview. As identified above, the user interface is configured to enable a user to manually select specific file content from complete contents of the archived file or enter search terms for browsing contents of the archived file. Such functionality is provided through the displayed preview of the archived file. Processing operations for extracting a subset of file content from an archived file are known to one skilled in the field of art. Examples of navigation between files/folders of an archived file as well as selection of specific file content are illustrated in FIGS. 2A-2C.

Flow of method 100 may proceed to processing operation 110, where access is granted to specific file content that is extracted from the archived file. Access to the specifically extracted file content may comprise any of a number of actions including but not limited to: downloading the specific file content, viewing the specific file content, copying the specific file content to a computing device/storage and creation of a new file/folder (e.g. recursive zip file), among other examples.

In one example, processing operation 110 comprises downloading, to a computing device of the user or a distributed storage account associated with a user, a file from the file content of the archived file, for example, based on the selection of the specific file content. Examples described herein referencing a computer storage associated with a user account of the user are intended to cover examples where a user downloads the specific file content to a storage of a client computing device (which may be associated with a user account of the computing device) as well as storage (physical or virtual) associated with a distributed storage service where a user may be allocated storage space. In another example, processing operation 110, comprises downloading, to a computing device of the user or a distributed storage account associated with a user, a folder from the file content of the archived file where the folder comprises the specific file content. In yet another example, processing operation 110 comprises downloading, to a computing device of the user or a distributed storage account associated with a user, a directory of files from the file content of the archived file, where the directory of files comprises the specific file content. Further examples of processing operation 110 comprise viewing the specific file content via a computing device of the user. It is to be understood that examples referencing viewing of the specific file content using a computing device are intended to also include examples where a display is connected with the computing device (e.g. separate display attached/connected with the computing device). In web-based service examples, viewing of the specific file content may comprise processing operations related to transmission of the specific file content to a client computing device of a user, where one or more different devices may be utilized in the processing or viewing of content. Further examples extend to multimodal functionality, where specific file content may be transmitted to different computing devices of a user.

In further examples, processing operation 110 further comprises surfacing a prompt for the user to select an application or service that is used to access the specific file content. For example, specific content may be opened using certain applications, where an exemplary application/service can be configured to assist users to identify such applications/services through user interface prompts. In other examples, processing operation 110 may comprise surfacing of a prompt to assist a user with selection of a modality for accessing the specific content. In yet another example, processing operation 110 may comprise surfacing of a prompt to assist a user with sharing the specific file content with other user accounts and/or computing devices.

Method 100 may proceed to processing operation 112, where the specific file content may be displayed. For example, the specific file content may be downloaded on a client computing device of a user, where the content may be selected and opened on the client computing device. In another example, the specific file content may be displayed (processing operation 112) through a web browser or online application/service, for example, that may be accessed through a web browser.

Flow may proceed to decision operation 114, where it is determined if subsequent action is received such as selection of additional file content, searching of file content of the archived file, etc. If no subsequent action is not received, decision operation 114 branches NO and processing of method 100 remains idle until an archived file is re-accessed or a new archived file is accessed. If subsequent action is received through the user interface, flow of decision operation 114 branches YES and processing of method 100 returns back to processing operation 106 where selection of file content of the archived file may be evaluated.

FIGS. 2A-2C are exemplary processing device views illustrating operation of an application/service that provides an exemplary preview of an archived file and management options for specific content of the archived file with which aspects of the present disclosure may be practiced. Processing device views provided in FIGS. 2A-2C are intended to supplement and further extend the technical description provided in method 100, for example, for management of archived files through a displayed preview.

Processing device view 200 (FIG. 2A) provides a user interface that is accessing a displayed preview of an archived file folder (e.g. archived file). In the example shown in processing device view 200, the archived file folder comprises a folder 204 (“Trip Pics Folder) that comprises additional file content. The user may select the folder 204, which triggers an update to the user interface of the application/service. For example, selection of the folder 204 triggers update of the user interface to display a selection box 206 indicating that the folder 204 is selected. Additional user interface features may be displayed to assist a user with managing content of the archived file. For example, user interface feature 208 may be displayed to easily and efficiently enable a user to download the selected folder. User interface feature 210 may also be displayed to easily and efficiently enable the user to drill into the selected folder. It is to be understood that processing device view 200 illustrates one of many possible user interface examples. Other methods of selecting and accessing specific file content (e.g. through mouse devices (single click, double click, right click and menu selection, touch input, voice input, etc.) are to be understood as included herein without departing from the spirit of the present disclosure. Furthermore, processing device view 200 further comprises a search interface feature 202 that enables a user to search contents of an archived file folder.

Processing device view 220 (FIG. 2B) provides a user interface that is accessing a displayed preview of an archived file folder (e.g. archived file). Processing device view 220 is intended as a continuation of the example shown in processing device view 200, where a user has selected the folder 204 and is drilling into the contents of folder 204. In processing device view 220, the displayed preview is updated to show contents 222 of folder 204. As seen in processing device view 220, a user can view specific content within folder 204. In alternate examples, as referenced in method 100, additional types of previews of specific content may be possible through the displayed preview. For instance, if a user selects (or alternatively hovers over) specific file content, the user may be able to see a portion or all of that file content without having to download the file content.

Processing device view 230 (FIG. 2C) provides a user interface that is accessing a displayed preview of an archived file folder (e.g. archived file). Processing device view 230 is intended as a continuation of the example shown in processing device view 220, where a user is accessing the contents 222 of folder 204. In processing device view 230, the displayed preview is updated when the user selects specific file content of the contents 222 of folder 204. As can be seen in processing device view 230, user interface features 232 are displayed when one or more specific files are selected for extraction. In additional examples, the user interface is further configured to display user interface feature 234 to enable a user to easily and efficiently download the specific file content from the archived file.

FIGS. 3-5 and the associated descriptions provide a discussion of a variety of operating environments in which examples of the invention may be practiced. However, the devices and systems illustrated and discussed with respect to FIGS. 3-5 are for purposes of example and illustration and are not limiting of a vast number of computing device configurations that may be utilized for practicing examples of the invention, described herein.

FIG. 3 is a block diagram illustrating physical components of a computing device 302, for example a mobile processing device, with which examples of the present disclosure may be practiced. Among other examples, computing device 302 may be an exemplary computing device configured for execution of processing operations related to management of an exemplary preview of an archived file as described herein. In a basic configuration, the computing device 302 may include at least one processing unit 304 and a system memory 306. Depending on the configuration and type of computing device, the system memory 306 may comprise, but is not limited to, volatile storage (e.g., random access memory), non-volatile storage (e.g., read-only memory), flash memory, or any combination of such memories. The system memory 306 may include an operating system 307 and one or more program modules 308 suitable for running software programs/modules 320 such as IO manager 324, other utility 326 and application 328. As examples, system memory 306 may store instructions for execution. Other examples of system memory 306 may store data associated with applications. The operating system 307, for example, may be suitable for controlling the operation of the computing device 302. Furthermore, examples of the invention may be practiced in conjunction with a graphics library, other operating systems, or any other application program and is not limited to any particular application or system. This basic configuration is illustrated in FIG. 3 by those components within a dashed line 322. The computing device 302 may have additional features or functionality. For example, the computing device 302 may also include additional data storage devices (removable and/or non-removable) such as, for example, magnetic disks, optical disks, or tape. Such additional storage is illustrated in FIG. 3 by a removable storage device 309 and a non-removable storage device 310.

As stated above, a number of program modules and data files may be stored in the system memory 306. While executing on the processing unit 304, program modules 308 (e.g., Input/Output (I/O) manager 324, other utility 326 and application 328) may perform processes including, but not limited to, one or more of the stages of the operations described throughout this disclosure. Other program modules that may be used in accordance with examples of the present invention may include electronic mail and contacts applications, word processing applications, spreadsheet applications, database applications, slide presentation applications, drawing or computer-aided application programs, photo editing applications, authoring applications, etc.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 3 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality described herein may be operated via application-specific logic integrated with other components of the computing device 402 on the single integrated circuit (chip). Examples of the present disclosure may also be practiced using other technologies capable of performing logical operations such as, for example, AND, OR, and NOT, including but not limited to mechanical, optical, fluidic, and quantum technologies. In addition, examples of the invention may be practiced within a general purpose computer or in any other circuits or systems.

The computing device 302 may also have one or more input device(s) 312 such as a keyboard, a mouse, a pen, a sound input device, a device for voice input/recognition, a touch input device, etc. The output device(s) 314 such as a display, speakers, a printer, etc. may also be included. The aforementioned devices are examples and others may be used. The computing device 302 may include one or more communication connections 316 allowing communications with other computing devices 318. Examples of suitable communication connections 316 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 306, the removable storage device 309, and the non-removable storage device 310 are all computer storage media examples (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 302. Any such computer storage media may be part of the computing device 302. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

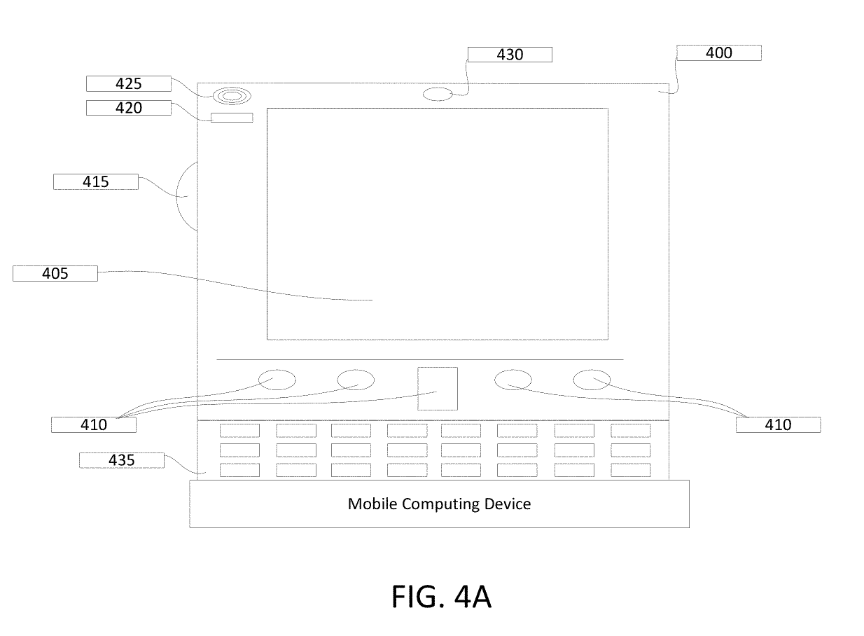

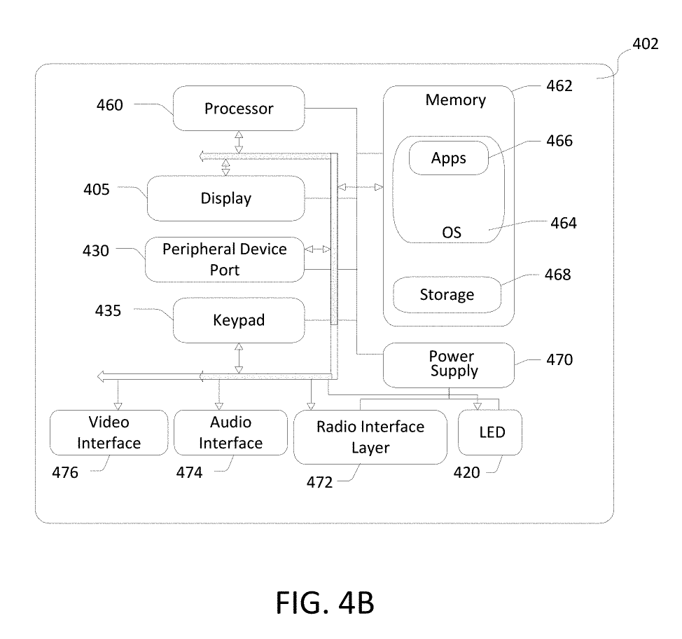

FIGS. 4A and 4B illustrate a mobile computing device 400, for example, a mobile telephone, a smart phone, a personal data assistant, a tablet personal computer, a phablet, a slate, a laptop computer, and the like, with which examples of the invention may be practiced. Mobile computing device 400 may be an exemplary computing device configured for processing operations related to management of an exemplary preview of an archived file as described herein. Application command control may be provided for applications executing on a computing device such as mobile computing device 400. Application command control relates to presentation and control of commands for use with an application through a user interface (UI) or graphical user interface (GUI). In one example, application command controls may be programmed specifically to work with a single application. In other examples, application command controls may be programmed to work across more than one application. With reference to FIG. 4A, one example of a mobile computing device 400 for implementing the examples is illustrated. In a basic configuration, the mobile computing device 400 is a handheld computer having both input elements and output elements. The mobile computing device 400 typically includes a display 405 and one or more input buttons 410 that allow the user to enter information into the mobile computing device 400. The display 405 of the mobile computing device 400 may also function as an input device (e.g., touch screen display). If included, an optional side input element 415 allows further user input. The side input element 415 may be a rotary switch, a button, or any other type of manual input element. In alternative examples, mobile computing device 400 may incorporate more or less input elements. For example, the display 405 may not be a touch screen in some examples. In yet another alternative example, the mobile computing device 400 is a portable phone system, such as a cellular phone. The mobile computing device 400 may also include an optional keypad 435. Optional keypad 435 may be a physical keypad or a “soft” keypad generated on the touch screen display or any other soft input panel (SIP). In various examples, the output elements include the display 405 for showing a GUI, a visual indicator 420 (e.g., a light emitting diode), and/or an audio transducer 425 (e.g., a speaker). In some examples, the mobile computing device 400 incorporates a vibration transducer for providing the user with tactile feedback. In yet another example, the mobile computing device 400 incorporates input and/or output ports, such as an audio input (e.g., a microphone jack), an audio output (e.g., a headphone jack), and a video output (e.g., a HDMI port) for sending signals to or receiving signals from an external device.

FIG. 4B is a block diagram illustrating the architecture of one example of a mobile computing device. That is, the mobile computing device 400 can incorporate a system (i.e., an architecture) 402 to implement some examples. In one examples, the system 402 is implemented as a “smart phone” capable of running one or more applications (e.g., browser, e-mail, calendaring, contact managers, messaging clients, games, and media clients/players). In some examples, the system 402 is integrated as a computing device, such as an integrated personal digital assistant (PDA), tablet and wireless phone.

One or more application programs 466 may be loaded into the memory 462 and run on or in association with the operating system 464. Examples of the application programs include phone dialer programs, e-mail programs, personal information management (PIM) programs, word processing programs, spreadsheet programs, Internet browser programs, messaging programs, and so forth. The system 402 also includes a non-volatile storage area 468 within the memory 462. The non-volatile storage area 468 may be used to store persistent information that should not be lost if the system 402 is powered down. The application programs 466 may use and store information in the non-volatile storage area 468, such as e-mail or other messages used by an e-mail application, and the like. A synchronization application (not shown) also resides on the system 402 and is programmed to interact with a corresponding synchronization application resident on a host computer to keep the information stored in the non-volatile storage area 468 synchronized with corresponding information stored at the host computer. As should be appreciated, other applications may be loaded into the memory 462 and run on the mobile computing device (e.g. system 402) described herein.

The system 402 has a power supply 470, which may be implemented as one or more batteries. The power supply 470 might further include an external power source, such as an AC adapter or a powered docking cradle that supplements or recharges the batteries.

The system 402 may include peripheral device port 430 that performs the function of facilitating connectivity between system 402 and one or more peripheral devices. Transmissions to and from the peripheral device port 430 are conducted under control of the operating system (OS) 464. In other words, communications received by the peripheral device port 430 may be disseminated to the application programs 466 via the operating system 464, and vice versa.

The system 402 may also include a radio interface layer 472 that performs the function of transmitting and receiving radio frequency communications. The radio interface layer 472 facilitates wireless connectivity between the system 402 and the “outside world,” via a communications carrier or service provider. Transmissions to and from the radio interface layer 472 are conducted under control of the operating system 464. In other words, communications received by the radio interface layer 472 may be disseminated to the application programs 566 via the operating system 464, and vice versa.

The visual indicator 420 may be used to provide visual notifications, and/or an audio interface 474 may be used for producing audible notifications via the audio transducer 425 (as described in the description of mobile computing device 400). In the illustrated example, the visual indicator 420 is a light emitting diode (LED) and the audio transducer 425 is a speaker. These devices may be directly coupled to the power supply 470 so that when activated, they remain on for a duration dictated by the notification mechanism even though the processor 460 and other components might shut down for conserving battery power. The LED may be programmed to remain on indefinitely until the user takes action to indicate the powered-on status of the device. The audio interface 474 is used to provide audible signals to and receive audible signals from the user. For example, in addition to being coupled to the audio transducer 425 (shown in FIG. 4A), the audio interface 474 may also be coupled to a microphone to receive audible input, such as to facilitate a telephone conversation. In accordance with examples of the present invention, the microphone may also serve as an audio sensor to facilitate control of notifications, as will be described below. The system 402 may further include a video interface 476 that enables an operation of an on-board camera 430 to record still images, video stream, and the like.

A mobile computing device 400 implementing the system 402 may have additional features or functionality. For example, the mobile computing device 400 may also include additional data storage devices (removable and/or non-removable) such as, magnetic disks, optical disks, or tape. Such additional storage is illustrated in FIG. 4B by the non-volatile storage area 468.

Data/information generated or captured by the mobile computing device 400 and stored via the system 402 may be stored locally on the mobile computing device 400, as described above, or the data may be stored on any number of storage media that may be accessed by the device via the radio 472 or via a wired connection between the mobile computing device 400 and a separate computing device associated with the mobile computing device 400, for example, a server computer in a distributed computing network, such as the Internet. As should be appreciated such data/information may be accessed via the mobile computing device 400 via the radio 472 or via a distributed computing network. Similarly, such data/information may be readily transferred between computing devices for storage and use according to well-known data/information transfer and storage means, including electronic mail and collaborative data/information sharing systems.

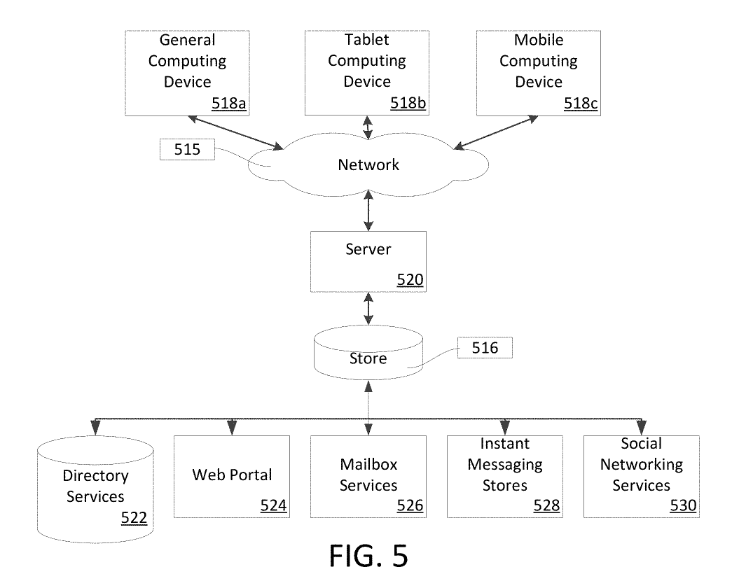

FIG. 5 illustrates one example of the architecture of a system for providing an application that reliably accesses target data on a storage system and handles communication failures to one or more client devices, as described above. The system of FIG. 5 may be an exemplary system configured for processing operations related to management of an exemplary preview of an archived file as described herein. Target data accessed, interacted with, or edited in association with programming modules 308 and/or applications 320 and storage/memory (described in FIG. 3) may be stored in different communication channels or other storage types. For example, various documents may be stored using a directory service 522, a web portal 524, a mailbox service 526, an instant messaging store 528, or a social networking site 530, IO manager 324, other utility 326, application 328 and storage systems may use any of these types of systems or the like for enabling data utilization, as described herein. A server 520 may provide storage system for use by a client operating on general computing device 302 and mobile device(s) 400 through network 515. By way of example, network 515 may comprise the Internet or any other type of local or wide area network, and a client node may be implemented for connecting to network 515. Examples of a client node comprise but are not limited to: a computing device 302 embodied in a personal computer, a tablet computing device, and/or by a mobile computing device 400 (e.g., mobile processing device). As an example, a client node may connect to the network 515 using a wireless network connection (e.g. WiFi connection, Bluetooth, etc.). However, examples described herein may also extend to connecting to network 515 via a hardwire connection. Any of these examples of the client computing device 302 or 400 may obtain content from the store 516.

Reference has been made throughout this specification to “one example” or “an example,” meaning that a particular described feature, structure, or characteristic is included in at least one example. Thus, usage of such phrases may refer to more than just one example. Furthermore, the described features, structures, or characteristics may be combined in any suitable manner in one or more examples.

One skilled in the relevant art may recognize, however, that the examples may be practiced without one or more of the specific details, or with other methods, resources, materials, etc. In other instances, well known structures, resources, or operations have not been shown or described in detail merely to observe obscuring aspects of the examples.

While sample examples and applications have been illustrated and described, it is to be understood that the examples are not limited to the precise configuration and resources described above. Various modifications, changes, and variations apparent to those skilled in the art may be made in the arrangement, operation, and details of the methods and systems disclosed herein without departing from the scope of the claimed examples.

What is claimed is:

1. A method comprising:
receiving a selection of an archived file;
displaying, through a user interface, a preview of the archived file based on the received selection of the archived file, wherein the preview of the archived file comprises file content of the archived file that is accessed without downloading of the archived file;
extracting specific file content from the archived file based on a selection of the specific file content from the displayed preview, wherein the user interface is configured to enable a user to manually select the specific file content from complete contents of the archived file; and
providing access to the specific file content that is extracted from the archived file.

2. The method of claim 1, wherein the providing of the access to the specific file content further comprises downloading, to a computer storage associated with a user account of the user, a file from the file content of the archived file.

3. The method of claim 1, wherein the providing of the access to the specific file content further comprises downloading, to a computer storage associated with a user account of the user, a folder from the file content of the archived file, wherein the folder comprises the specific file content.

4. The method of claim 1, wherein the providing of the access to the specific file content further comprises downloading, to a computer storage associated with a user account of the user, a directory of files from the file content of the archived file, wherein the directory of files comprises the specific file content.

5. The method of claim 1, wherein the providing of the access to the specific file content further comprises viewing the specific file content via a computing device of the user.

6. The method of claim 1, wherein user interface is a component of a web service, and wherein the user interface, in providing of the access to the specific file content, further comprises surfacing a prompt for the user to select an application or service that is used to access the specific file content.

7. The method of claim 1, wherein the user interface further comprises a search component to enable the user to search for the specific file content from the complete contents of the archived file.

8. A system comprising:
at least one processor; and
a memory, operatively connected with the at least one processor, storing computer-executable instructions that, when executed by the at least one processor, causes the at least one processor to execute a method that comprises:
receiving a selection of an archived file;
displaying, through a user interface, a preview of the archived file based on the received selection of the archived file, wherein the preview of the archived file comprises file content of the archived file that is accessed without downloading of the archived file;
extracting specific file content from the archived file based on a selection of the specific file content from the displayed preview, wherein the user interface is configured to enable a user to manually select the specific file content from complete contents of the archived file; and
providing access to the specific file content that is extracted from the archived file.

9. The system of claim 8, wherein the providing of the access to the specific file content further comprises downloading, to a computer storage associated with a user account of the user, a file from the file content of the archived file.

10. The system of claim 8, wherein the providing of the access to the specific file content further comprises downloading, to a computer storage associated with a user account of the user, a folder from the file content of the archived file, wherein the folder comprises the specific file content.

11. The system of claim 8, wherein the providing of the access to the specific file content further comprises downloading, to a computer storage associated with a user account of the user, a directory of files from the file content of the archived file, wherein the directory of files comprises the specific file content.

12. The system of claim 8, wherein the providing of the access to the specific file content further comprises viewing the specific file content via the system.

13. The system of claim 8, wherein user interface is a component of a web service, and wherein the user interface, in providing of the access to the specific file content, further comprises surfacing a prompt for the user to select an application or service that is used to access the specific file content.

14. The system of claim 8, wherein the user interface further comprises a search component to enable the user to search for the specific file content from the complete contents of the archived file.

15. A computer-readable medium storing computer-executable instructions that, when executed by at least one processor, causes the at least one processor to execute a method comprising:
receiving a selection of an archived file;
displaying, through a user interface, a preview of the archived file based on the received selection of the archived file, wherein the preview of the archived file comprises file content of the archived file that is accessed without downloading of the archived file;
extracting specific file content from the archived file based on a selection of the specific file content from the displayed preview, wherein the user interface is configured to enable a user to manually select the specific file content from complete contents of the archived file; and
providing access to the specific file content that is extracted from the archived file.

16. The computer-readable medium of claim 15, wherein the providing of the access to the specific file content further comprises downloading, to a computer storage associated with a user account of the user, a file from the file content of the archived file.

17. The computer-readable medium of claim 15, wherein the providing of the access to the specific file content further comprises downloading, to a computer storage associated with a user account of the user, a folder from the file content of the archived file, wherein the folder comprises the specific file content.

18. The computer-readable medium of claim 15, wherein the providing of the access to the specific file content further comprises downloading, to a computer storage associated with a user account of the user, a directory of files from the file content of the archived file, wherein the directory of files comprises the specific file content.

19. The computer-readable medium of claim 15, wherein the providing of the access to the specific file content further comprises viewing the specific file content on a computing device of the user.

20. The computer-readable medium of claim 15, wherein user interface is a component of a web service, and wherein the user interface, in providing of the access to the specific file content, further comprises surfacing a prompt for the user to select an application or service that is used to access the specific file content.
